(19) United States
(12) Patent Application Publication
(10) Pub. No.: US 2022/0274810 A1
(43) Pub. Date: Sep. 1, 2022

(54) ESTIMATED LOAD VERIFICATION FOR OVERHEAD CRANES

(71) Applicant: Honda Motor Co., Ltd., Tokyo (JP)

(72) Inventor: Logan Tyrel MATHYS, DeGraff, OH (US)

(21) Appl. No.: 17/186,914

(22) Filed: Feb. 26, 2021

(51) Int. Cl. B66C 13/48; B66C 13/50; B66C 13/16; B66C 15/00; B66C 15/06; B66C 13/46; G05D 15/01

(52) U.S. Cl. CPC B66C 13/48; B66C 13/50; B66C 13/16; B66C 15/00; B66C 15/06; B66C 13/46; G05D 15/01; B66C 17/00

(57) ABSTRACT

A load verification system includes a first sensor configured to determine an identifier associated with a target object, a second sensor configured to determine a load borne by a machine handling the target object, and a controller configured to determine a load threshold based on the identifier, compare the load with the load threshold to determine whether the load threshold is exceeded, and, on condition that the load threshold is exceeded, selectively restrict movement of the machine.

### BACKGROUND

Overhead cranes and other lifting machines may be used to lift and transport large objects. During operation, overhead cranes may endure various forces, including forces from shock loading, side loading, swaying loads, and/or drifting loads. Overhead cranes may be more susceptible to stress and damage when overloaded. For example, attempting to lift a stamping die that is inadvertently clamped or bolted to a press bolster may cause damage to the stamping die and/or overhead crane, potentially resulting in costly maintenance or repair, loss of production due to equipment downtime, and/or safety concerns from overload stress. At least some known overhead cranes may be configured to automatically stop and/or shut off when the forces endured by the overhead crane exceed a rated capacity or predetermined weight limit of the overhead crane. However, repeatedly encountering the rated capacity over time may cause excess wear and tear to one or more portions of the overhead crane.

### SUMMARY

Examples of this disclosure enable an overhead crane and other lifting mechanisms to verify an estimated load. In one aspect, a load verification system is provided. The load verification system may include a first sensor configured to determine an identifier associated with a target object, a second sensor configured to determine a load borne by a machine handling the target object, and a controller configured to determine a load threshold based on the identifier, compare the load with the load threshold to determine whether the load threshold is exceeded, and, on condition that the load threshold is exceeded, selectively restrict movement of the machine.

In another aspect, a control system is provided for use with an overhead crane. The control system may include a scan unit configured to identify an object associated with the overhead crane, a load unit configured to determine a load borne by the overhead crane, and a regulator unit configured to determine a load threshold of the overhead crane based on the identified object and compare the load with the load threshold to determine an operating mode of the overhead crane.

In yet another aspect, a method is provided for verifying a load for use with an overhead crane. The method may include determining an identifier to identify an object associated with the identifier, determining a load threshold of the overhead crane based on the identified object, determining a load borne by the overhead crane when the object is coupled to the overhead crane, and comparing the load with the load threshold to determine an operating mode of the overhead crane.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

The novel features believed to be characteristic of the disclosure are set forth in the appended claims. The drawings are not necessarily drawn to scale and certain drawings may be shown in exaggerated or generalized form in the interest of clarity and conciseness. The disclosure itself, however, will be best understood by reference to the following Detailed Description when read in conjunction with the accompanying drawings, wherein:

FIG. 1 is a schematic overhead view of an example overhead crane;

FIG. 2 is a schematic side view of an example hoist that may be used with a lifting machine, such as the overhead crane shown in FIG. 1;

FIG. 3 is a conceptual view of an example control system that may be used to control one or more operations of a lifting machine, such as the overhead crane shown in FIG. 1;

FIG. 4 is a schematic view of the control system shown in FIG. 3;

FIG. 5 is a block diagram of an example computing system that may be used to control one or more operations of a lifting machine, such as the overhead crane shown in FIG. 1; and

FIG. 6 is a flowchart of an example method of verifying a load borne by a lifting machine, such as the overhead crane shown in FIG. 1.

Like parts are marked throughout the drawings, as well as throughout the Detailed Disclosure, with the same numerals. Although specific features may be shown in some of the drawings and not in others, this is for convenience only. In accordance with the examples described herein, any feature of a drawing may be referenced and/or claimed in combination with any feature of any other drawing.

### DETAILED DESCRIPTION

The present disclosure relates to lifting machines and, more particularly, to verifying estimated loads for overhead cranes. Examples described herein include a handling member that handles a target object, a first sensor that determines an identifier associated with the target object, a second sensor that determines a load borne by the handling member, and a controller that compares the load with a load threshold associated with the target object to determine whether the load threshold is exceeded. If the load threshold is exceeded, the controller may selectively restrict movement of the handling member. In this manner, the examples described herein promote safety and efficiency by ensuring that the lifting machine is able to withstand a load. Other benefits and advantages will become clear from the disclosure provided herein, and those advantages provided are for illustration.

Examples described herein are configured to operate using one or more computer systems that are communicatively coupled to one or more sensors and operably connected to one or more actuators. For example, the technical effect of the systems and processes described herein may be achieved by performing at least one of the following operations: (i) identifying an object associated with the overhead crane, (ii) determining a load borne by the overhead crane, (iii) determining a load threshold of the overhead crane based on the identified object, (iv) comparing the load with the load threshold, and/or (v) determining an operating mode of the overhead crane. The systems and processes described herein may be implemented using computer programming or engineering techniques including computer software, firmware, hardware or a combination or subset thereof. While the examples described herein are described with respect to the operation of lifting machines, one of ordinary skill in the art would understand and appreciate that the subject matter described herein may be used for various other uses and/or applications.

Certain terminology is used in the present disclosure for convenience and reference only and not in a limiting sense. For example, the terms “raise,” “lower,” “upwards,” “downwards,” “vertical,” and the like designate directions in relation to the perspective shown in the drawings. One of ordinary skill in the art would understand and appreciate that the example methods and systems may be used in various orientations.

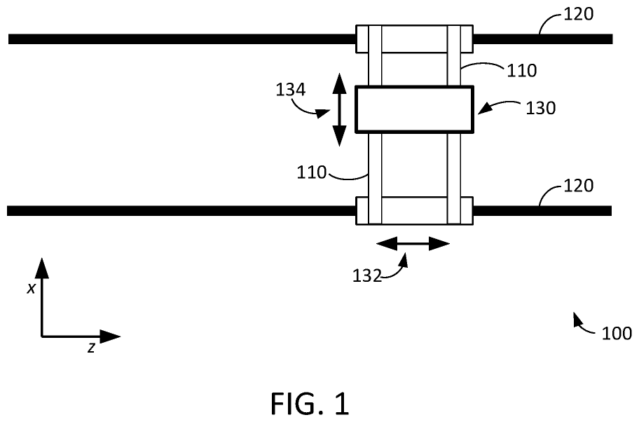

FIG. 1 shows an example overhead crane 100 that may be used to handle or transport one or more objects, such as a stamping die. The overhead crane 100 may be configured to lift, lower, and/or horizontally move the objects. The overhead crane 100 may include one or more bridges 110 extending between a plurality of beams 120 and one or more trolleys 130 mounted on or coupled to the bridges 110. In some examples, the bridges 110 are moveable along the beams 120 in a first axis of motion 132 (e.g., along the Z-axis), and the trolleys 130 are moveable along the bridge 110 in a second axis of motion 134 (e.g., along the X-axis) generally perpendicular to the first axis of motion 132.

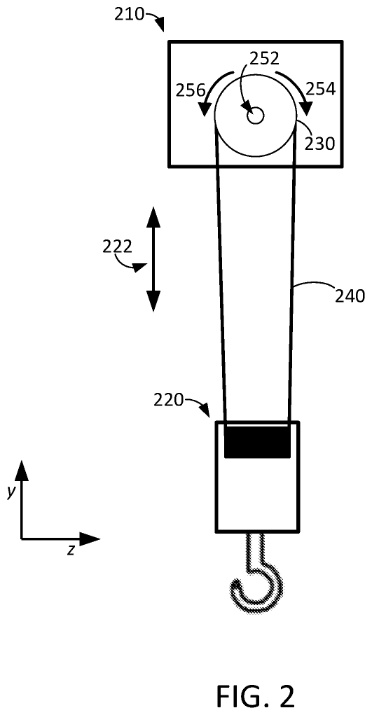

FIG. 2 shows an example hoist 200 that may be coupled to the trolley 130. The hoist 200 may be configured to exert a force for lifting or lowering a target object (e.g., stamping die). In some examples, the hoist 200 includes an extension member 210 and a handling member 220 coupled to the extension member 210. The handling member 220 is coupleable to one or more objects for handling and/or transporting the objects. Example handling members 220 may include, without limitation, a hook block, a clamshell bucket, a grapple, a magnet, and/or any other mechanism configured to handle one or more objects. In some examples, the handling member 220 is moveable between an open configuration and a closed configuration for selectively handling one or more objects.

In some examples, the extension member 210 is moveable between a contracted configuration and an extended configuration to selectively position the handling member 220. The extension member 210 may be moved, for example, in a third axis of motion 222 (e.g., along the Y-axis) generally perpendicular to the first axis of motion 132 and/or second axis of motion 134. As shown in FIG. 2, the extension member 210 may include a wheel 230 and a cable 240 extendable about the wheel 230. The cable 240 may be fabricated from one or more materials, including, without limitation, a steel material, a nylon material, and/or a plastic material. Example cables 240 may include, without limitation, a chain, a fiber, a wire, a rope, and/or any other mechanism configured to selectively position the handling member 220.

In some examples, the extension member 210 includes a motor operably coupled to the wheel 230 and/or cable 240 to selectively rotate the wheel 230 about an axis of rotation 252. The wheel 230 may be rotated, for example, to move the extension member 210 between the contracted configuration and extended configuration. When the wheel 230 is selectively rotated in a first direction 254 (e.g., a clockwise direction), the cable 240 may wind about the wheel 230 to move the extension member 210 toward the contracted configuration. On the other hand, when the wheel 230 is selectively rotated in a second direction 256 (e.g., a counterclockwise direction) opposite the first direction 254, the cable 240 may unwind from the wheel 230 to move the extension member 210 toward the extended configuration. In some examples, a brake system is used to selectively restrict rotation of the wheel 230 and/or motor. While the overhead crane 100 is described and shown herein as being capable of vertically raising or lowering an object, one of ordinary skill in the art would understand and appreciate that the examples described herein may be configured to move an object in any direction, including in a horizontal direction.

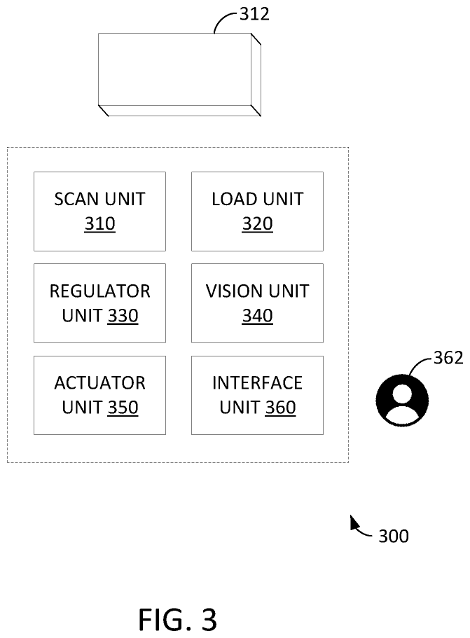

FIG. 3 shows a control system 300 that may be used to manage or control one or more operations of the overhead crane 100. The control system 300 may include a scan unit 310 that identifies a target object 312 (e.g., stamping die), a load unit 320 that determines a load of the overhead crane 100, and a regulator unit 330 that compares the load with a load threshold associated with the target object 312 to determine an operating mode of the overhead crane 100. For example, the overhead crane 100 may operate in a normal operating mode when the load borne or sustained by the overhead crane 100 is less than or equal to the load threshold, and operate in a loaded operating mode when the load borne or sustained by the overhead crane 100 exceeds or is greater than the load threshold.

In some examples, the load unit 320 includes a spring, piezoelectric transducer, and/or hydraulic ram, and is configured to determine the load based on an amount the spring is stretched or compressed, an amount of current flowing through the piezoelectric transducer, and/or an amount of hydraulic pressure in the hydraulic ram, respectively. Additionally or alternatively, the load unit 320 may determine the load based on one or more other factors, such as a position, torque, and/or rotation speed associated with the overhead crane 100. For example, when the overhead crane 100 is operated to selectively move the handling member 220 (e.g., using the actuator unit 350), the load unit 320 may determine the load based on a comparison of a detected location of the handling member 220 and an expected location of the handling member 220, a comparison of a detected torque of the extension member 210 and an expected torque of the extension member 210, and/or a comparison of a detected rotation speed of the wheel 230 and an expected rotation speed of the wheel 230. Any discrepancies between the detected location, torque, and/or rotation speed and the expected location, torque, and/or rotation speed may be indicative of the overhead crane 100 bearing a load that is greater than the load threshold.

As shown in FIG. 3, the control system 300 may also include a vision unit 340 that determines a location of one or more objects (e.g., target object 312) in an environment, an actuator unit 350 that moves or restricts movement of one or more portions of the overhead crane 100 (e.g., bridge 110, trolley 130, hoist 200, extension member 210, handling member 220), and/or an interface unit 360 that receives information from and presents information to an operator 362 of the control system 300. In some examples, the vision unit 340 and actuator unit 350 are used to selectively move and/or position one or more portions of the overhead crane 100 in the environment, and the interface unit 360 allows the operator 362 to manage or control one or more operations of the overhead crane 100.

In some examples, movement of the target object 312 may affect the load determined by the load unit 320. That is, the load determined by the load unit 320 may change or fluctuate when the target object 312 is in motion. For example, the load unit 320 may determine a first load when the target object 312 is stationary and a second load when the target object 312 is in motion. In some examples, a target object 312 handled by the handling member 220 may continue to move (e.g., sway) after the overhead crane 100 is operated to selectively move the handling member 220 (e.g., using the actuator unit 350).

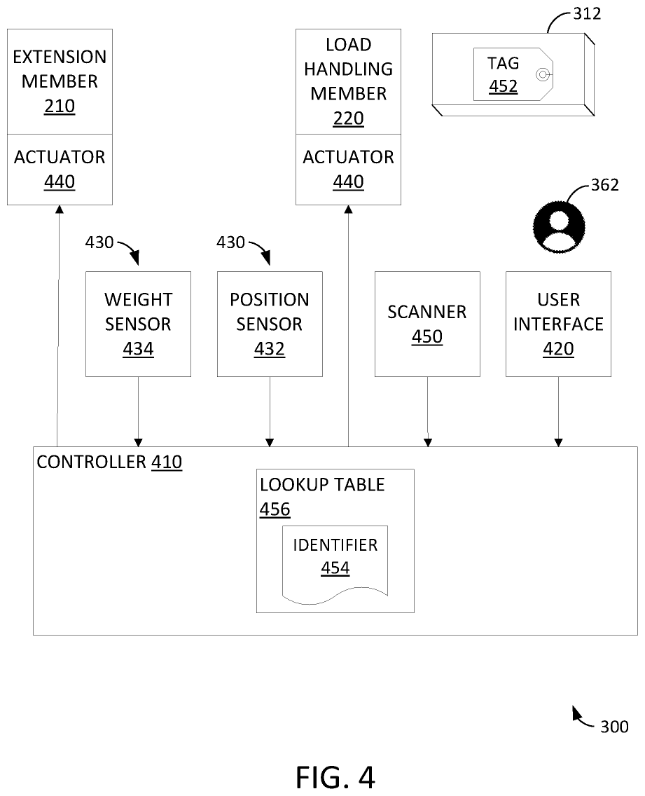

FIG. 4 shows the control system 300 including a controller 410 that may be used to manage or control one or more operations of the overhead crane 100. The controller 410 may include or be coupled to a user interface 420 that allows a user (e.g., operator 362) to enter one or more commands for selectively controlling one or more operations of the overhead crane 100. The controller 410 may be used, for example, to selectively control movement of a bridge 110 in the first axis of motion 132, a trolley 130 in the second axis of motion 134, an extension member 210 in the third axis of motion 222, and/or a handling member 220 between the open configuration and the closed configuration.

In some examples, the controller 410 controls one or more operations of the overhead crane 100 based on one or more parameters (e.g., load, position, torque, rotation speed) detected and/or identified using one or more feedback devices 430. The feedback devices 430 may be used to monitor an environment of the overhead crane 100. In some examples, the feedback devices 430 generates one or more signals or sensor data based on one or more stimuli detected by the feedback devices 430. Sensor data may include any information that enables a computing device (e.g., controller 410) to map or understand the overhead crane 100, the environment of the overhead crane 100, and/or various objects in the environment. In some examples, the feedback devices 430 include one or more position sensors 432 and one or more load sensors 434.

Position sensors 432 may be used to detect or identify a position and/or location of one or more portions of the overhead crane 100 (e.g., bridge 110, trolley 130, hoist 200, extension member 210, handling member 220) and/or one or more objects in the environment (e.g., target object 312). A location of the target object 312, for example, may be determined relative to a location of the overhead crane 100, bridge 110, trolley 130, hoist 200, extension member 210, and/or handling member 220. In some examples, the position sensors 432 are coupled to the overhead crane 100 at one or more predetermined locations. Additionally or alternatively, one or more position sensors 432 may be remote from the overhead crane 100 and/or at one or more variable locations. Position sensors 432 may generate one or more signals or position data that enable a position or location to be determined. Example position sensors 432 may include, without limitation, optical sensors, proximity sensors, range sensors, speed sensors, force sensors, torque sensors, potentiometers, electromagnetic sensors, inertial measurement units (IMUs), accelerometers, and/or gyroscopes.

Load sensors 434 may be used to detect or identify a weight of one or more objects (e.g., target object 312) being handled or lifted by the overhead crane 100 for use in monitoring a load borne or sustained by the overhead crane 100. In some examples, the overhead crane 100 operates in a normal operating mode when the load borne or sustained by the overhead crane 100 is less than or equal to the load threshold, and in a loaded operating mode when the load borne or sustained by the overhead crane 100 exceeds or is greater than the load threshold. Load sensors 434 may generate one or more signals or load data that enable a load to be determined. Example load sensors 434 may include, without limitation, strain gauges, load cells, force sensors, torque sensors, and/or speed sensors.

The controller 410 may communicate with the feedback devices 430 to generate control data based on the sensor data. Control data may include information that enables a computing device (e.g., controller 410) to control or operate some aspect of the overhead crane 100. Control data may be used, for example, to operate or control one or more actuators 440 (e.g., motor, brake system) to selectively control movement of the bridge 110, trolley 130, hoist 200, extension member 210, and/or handling member 220.

In some examples, the controller 410 includes or is coupled to one or more scanners 450 configured to scan one or more tags 452 coupled to or associated with one or more target objects 312. Each tag 452 may be associated with an identifier 454 that enables a corresponding target object 312 to be uniquely identified. Example tags 452 may include, without limitation, a barcode, a matrix barcode, a magnetic strip, a radio-frequency identification (RFID) tag, and/or any other mechanism configured to store information (e.g., identifier 454). Identifiers 454 may be stored, for example, in a lookup table 456, along with other information associated with the target objects 312 (e.g., weight, position).

In some examples, the controller 410 is configured to communicate with the user interface 420, feedback devices 430 (e.g., position sensor 432, load sensor 434), actuators 440, and/or scanners 450 using one or more wireless communication protocols. Example wireless communication protocols include, without limitation, wireless protocols, a BLUETOOTH® brand communication protocol, a ZIGBEE® brand communication protocol, a Z-WAVE™ brand communication protocol, a WI-FI® brand communication protocol, a near field communication (NFC) communication protocol, a radio frequency (RF) communication protocol, an infrared (IR) communication protocol, an ultrasound (US) communication protocol, and/or a cellular data communication protocol. (BLUETOOTH® is a registered trademark of Bluetooth Special Interest Group, ZIGBEE® is a registered trademark of ZigBee Alliance Corporation, Z-WAVE™ is a trademark of Sigma Designs, Inc., and WI-FI® is a registered trademark of the Wi-Fi Alliance.).

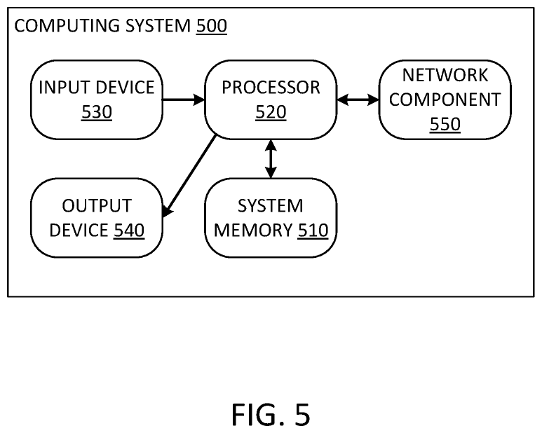

FIG. 5 shows an example computing system 500 configured to perform one or more computing operations. While some examples of the disclosure are illustrated and described herein with reference to the computing system 500 being included in a controller 410 (shown in FIG. 4), aspects of the disclosure are operable with any computing system (e.g., overhead crane 100, trolley 130, hoist 200, extension member 210, handling member 220, scan unit 310, load unit 320, regulator unit 330, vision unit 340, actuator unit 350, interface unit 360, user interface 420, feedback device 430, position sensor 432, load sensor 434, actuator 440, scanner 450) that executes instructions to implement the operations and functionality associated with the computing system 500. The computing system 500 shows only one example of a computing environment for performing one or more computing operations and is not intended to suggest any limitation as to the scope of use or functionality of the disclosure.

In some examples, the computing system 500 includes a system memory 510 (e.g., computer storage media) and a processor 520 coupled to the system memory 510. The processor 520 may include one or more processing units (e.g., in a multi-core configuration). Although the processor 520 is shown separate from the system memory 510, examples of the disclosure contemplate that the system memory 510 may be onboard the processor 520, such as in some embedded systems.

The processor 520 is programmed or configured to execute computer-executable instructions stored in the system memory 510 to monitor a load borne or sustained by an overhead crane 100 and/or implement other aspects of the disclosure using one or more controllers 410. The system memory 510 includes one or more computer-readable media that allow information, such as the computer-executable instructions and other data, to be stored and/or retrieved by the processor 520. In some examples, the processor 520 executes the computer-executable instructions to recognize or determine an identifier 454 to identify a corresponding target object 312, determine a load threshold of the overhead crane 100 based on the identified target object 312, determine a load borne or sustained by the overhead crane 100, and compare the load with the load threshold to determine an operating mode of the overhead crane 100.

By way of example, and not limitation, computer-readable media may include computer storage media and communication media. Computer storage media are tangible and mutually exclusive to communication media. For example, the system memory 510 may include computer storage media in the form of volatile and/or nonvolatile memory, such as read-only memory (ROM), programmable ROM (PROM), erasable PROM (EPROM), electrically erasable PROM (EEPROM), solid-state drives, magnetic tape, a floppy disk, a hard disk, a compact disc (CD), a digital versatile disc (DVD), a memory card, a flash drive, random-access memory (RAM), static RAM (SRAM), dynamic RAM (DRAM), synchronous DRAM (SDRAM), double data rate SDRAM (DDR SDRAM), and/or any other medium that may be used to store desired information that may be accessed by the processor 520. Computer storage media are implemented in hardware and exclude carrier waves and propagated signals. That is, computer storage media for purposes of this disclosure are not signals per se.

A user (e.g., operator 362) may enter commands and other input into the computing system 500 through one or more input devices 530 (e.g., user interface 420) coupled to the processor 520. The input devices 530 are configured to receive information. Example input device 530 include, without limitation, a pointing device (e.g., mouse, trackball, touch pad, joystick), a keyboard, a game pad, a controller, a microphone, a camera, a gyroscope, an accelerometer, a position detector, and an electronic digitizer (e.g., on a touchscreen). Information, such as text, images, video, audio, and the like, may be presented to a user via one or more output devices 540 (e.g., user interface 420) coupled to the processor 520. The output devices 540 are configured to convey information. Example output devices 540 include, without limitation, a monitor, a projector, a printer, a speaker, a vibrating component. In some examples, an output device 540 is integrated with an input device 530 (e.g., a capacitive touch-screen panel, a controller including a vibrating component).

One or more network components 550 may be used to operate the computing system 500 in a networked environment using one or more logical connections. Logical connections include, for example, local area networks, wide area networks, and the Internet. The network components 550 allow the processor 520, for example, to convey information to and/or receive information from one or more remote devices, such as another computing system or one or more remote computer storage media. Network components 550 may include a network adapter, such as a wired or wireless network adapter or a wireless data transceiver.

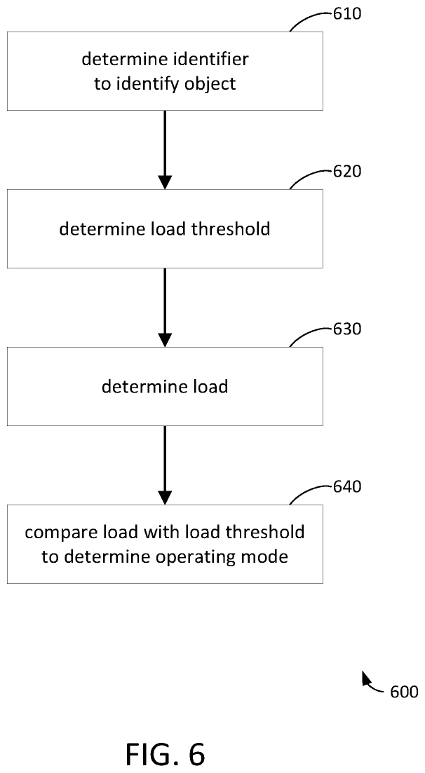

FIG. 6 shows various operations of an example method 600 of using a load verification system to verify a load for a machine (e.g., overhead crane 100). A user (e.g., operator 362) may use an user interface 420, for example, to control or operate the load verification system. In some examples, the machine includes a hoist 200 including a handling member 220 configured to handle one or more objects. The handling member 220 may be moveable between an open configuration and a closed configuration to selectively handle a target object 312. In some examples, the hoist 200 includes an extension member 210 configured to selectively move the handling member 220 along the Y-axis. Additionally, the hoist 200 may be coupled to a trolley 130 configured to move along a bridge 110 that is moveable along one or more beams 120 for selectively positioning the handling member 220 in the X-Z plane. The method 600 will be described with reference to the components of FIGS. 1-4, though it is to be appreciated that the method 600 may be used with other systems and/or components.

As shown at FIG. 6, an identifier 454 may be recognized or determined at operation 610 to identify an object associated with the identifier 454 (e.g., target object 312). In some examples, the identifier 454 allows the target object 312 to be uniquely identified. The identifier 454 may be determined by scanning or detecting a tag 452. For example, the identifier 454 may be included or incorporated in the tag 452 on or adjacent to a surface of the target object 312 as a barcode, a matrix barcode, a magnetic strip, a RFID tag, and/or any other mechanism configured to store information. In some examples, a scan unit 310 includes one or more first sensors (e.g., scanner 450) configured to scan the tag 452 and identify the target object 312 based on the identifier 454 associated with the tag 452. The target object 312 may be selected for identification based on a predetermined sequence of target objects 312 and/or user input received at the user interface 420.

A load threshold of the machine may be determined based on the target object 312 and/or identifier 454 at operation 620. In some examples, a regulator unit 330 automatically determines the load threshold based on a rated capacity of the machine and/or an expected weight of the target object 312. For example, if the rated capacity of the machine is less than or equal to the expected weight of the target object 312, then the rated capacity of the machine may be determined to be the load threshold. On the other hand, if the rated capacity of the machine exceeds or is greater than the expected weight of the target object 312, then the rated capacity of the machine may be determined to be the expected weight of the target object 312. The regulator unit 330 may determine the rated capacity of the machine and/or expected weight of the target object 312 using the lookup table 456, for example.

A load borne or sustained by the machine is determined at operation 630. In some examples, a load unit 320 includes one or more second sensors (e.g., load sensor 434) that determines a weight of a target object 312 for use in determining the load borne or sustained by the machine. The load unit 320 may determine the load, for example, by comparing a first force detected by the second sensors before a lift (e.g., when the target object 312 is on the ground) and a second force detected by the second sensors during a lift (e.g., when the target object 312 is in the air). In some examples, the load unit 320 determines the load while the target object 312 is in motion (e.g., when the target object 312 is moving in the first axis of motion 132, second axis of motion 134, and/or third axis of motion 222).

In some examples, the scan unit 310 and/or load unit 320 communicate with a vision unit 340, including one or more third sensors (e.g., position sensors 432) that detect a presence of one or more objects in an environment, and an actuator unit 350, including one or more actuators 440 that selectively move and/or position the first sensors and/or handling member 220, respectively, in the environment. For example, the first sensors and/or handling member 220 may be selectively moved to navigate around a first object (e.g., an obstacle) in the environment en route to the target object 312. In some examples, the handling member 220 is configured to open or close to selectively handle the target object 312. The scan unit 310 and/or load unit 320 may track or monitor a location of the first sensors, handling member 220, and/or target object 312, for example, by iteratively retrieving position data from the lookup table 456 and/or storing position data in the lookup table 456. In some examples, the vision unit 340 communicates with an interface unit 360 to present position data at the user interface 420.

The load is compared with the load threshold to determine an operating mode of the machine at operation 640. In some examples, the regulator unit 330 automatically switches the operating mode of the machine between a normal operating mode and a loaded operating mode. For example, the regulator unit 330 may switch the operating mode toward the normal operating mode when the determined load is less than or equal to the load threshold, and toward the loaded operating mode when the determined load exceeds or is greater than the load threshold.

In the normal operating mode, the machine may be free to move in one or more directions. One or more actuators 440, for example, may be used to selectively move one or more portions of the machine (e.g., bridge 110, trolley 130, hoist 200, extension member 210, handling member 220). Upon determining or recognizing that the machine is in the loaded operating mode, the regulator unit 330 may communicate with the interface unit 360 to present an alert or notification at the user interface 420 that the load threshold is exceeded.

In some examples, the bridge 110, trolley 130, hoist 200, extension member 210, and/or handling member 220 are allowed to move in one or more directions when the machine is in the loaded operating mode. For example, the user may choose to dismiss the notification and move the bridge 110, trolley 130, hoist 200, extension member 210, and/or handling member 220 in one or more desired directions (e.g., via manual override). In some examples, the bridge 110, trolley 130, hoist 200, extension member 210, and/or handling member 220 are restricted or prevented from moving in one or more directions (e.g., upwards) while being allowed to move in one or more other directions (e.g., downwards) when the machine is in the loaded operating mode. Alternatively, the bridge 110, trolley 130, hoist 200, extension member 210, and/or handling member 220 may be restricted or prevented from moving in any direction when the machine is in the loaded operating mode.

In some examples, the bridge 110, trolley 130, hoist 200, extension member 210, and/or handling member 220 are automatically stopped and moved in the opposite direction upon determining or recognizing that the machine is in the loaded operating mode. For example, if the handling member 220 is being vertically raised when the machine switches toward the loaded operating mode, the regulator unit 330 may automatically retract or reverse movement of the handling member 220 and vertically lower the handling member 220. In some examples, the vision unit 340 may be used to verify or confirm that an area below the handling member 220 is clear for lowering the handling member 220 and/or target object 312.

In some examples, one or more discrepancies between the detected load and the expected weight of the target object 312 may be flagged for investigation (e.g., to determine whether the target object 312 is secure, whether the target object 312 is clamped or bolted to a press bolster, whether there is scrap build up in the target object 312, etc.). Additionally or alternatively, one or more discrepancies between a detected location, torque, and/or rotation speed associated with the overhead crane 100 and an expected location, torque, and/or rotation speed may be flagged for investigation and/or calibration.

The following includes definitions of selected terms employed herein. The definitions include various examples and/or forms of components that fall within the scope of a term and that can be used for implementation. The examples are not intended to be limiting.

A “bus”, as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be or include, for example, magnetic tape, a floppy disk, a hard disk, a compact disc (CD), a digital versatile disc (DVD), a memory card, and/or a flash drive. The disk can store an operating system that controls or allocates resources of a computing device.

A “database”, as used herein can refer to table, a set of tables, and a set of data stores and/or methods for accessing and/or manipulating those data stores. Some databases can be incorporated with a disk as defined above.

A “memory”, as used herein can include non-volatile memory and/or volatile memory. Non-volatile memory can include, for example, read-only memory (ROM), programmable ROM (PROM), erasable PROM (EPROM), electrically erasable PROM (EEPROM), solid-state drives, and/or disks. Volatile memory can include, for example, random-access memory (RAM), static RAM (SRAM), dynamic RAM (DRAM), synchronous DRAM (SDRAM), and/or double data rate SDRAM (DDR SDRAM). The memory can store an operating system that controls or allocates resources of a computing device.

An “operable connection”, or a connection by which entities are “operably connected”, is one in which signals, physical communications, and/or logical communications can be sent and/or received. An operable connection can include a wireless interface, a physical interface, a data interface and/or an electrical interface.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various units to execute various functions.

A “unit”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another unit, method, and/or system. A unit may also include logic, a software controlled microprocessor, a discrete logic circuit, an analog circuit, a digital circuit, a programmed logic device, a memory device containing executing instructions, logic gates, a combination of gates, and/or other circuit components. Multiple units may be combined into one unit and single units may be distributed among multiple units.

A “value” and “level”, as used herein can include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage. In other cases, the value or level of X could be a value in a range. In still other cases, the value or level of X may not be a numerical value, but could be associated with a given discrete state, such as “not X”, “slightly X”, “X”, “very X” and “extremely X.”

Example lifting machines are described herein and illustrated in the accompanying drawings. The lifting machines described herein include or are coupled to a load verification system that monitors a load borne or sustained by the lifting machine in real time to protect the lifting machine from being overloaded. The load verification system may determine a load threshold for the lifting machine based on an expected load. In this manner, the lifting machine may be automatically stopped and/or retracted before becoming overloaded. Additionally, the lifting machine may present one or more alerts that allow an operator to manage and/or control one or more operations of the lifting machine based on objective information, rather than on subjective guesswork.

This written description uses examples to disclose aspects of the disclosure and also to enable a person skilled in the art to practice the aspects, including making or using the above-described systems and executing or performing the above-described methods.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense. For example, the examples described herein may be implemented and utilized in connection with many other applications such as, but not limited to, manufacturing and/or construction equipment.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

It should be apparent from the foregoing description that various examples may be implemented in hardware. Furthermore, various examples may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

When introducing elements, the articles “a”, “an”, “the” and “said” are intended to mean that there are one or more of the elements. References to an “embodiment” or an “example” of the present disclosure are not intended to be interpreted as excluding the existence of additional embodiments or examples that also incorporate the recited features. The terms “comprising”, “including” and “having” are intended to be inclusive and mean that there may be additional elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A load verification system comprising:
a first sensor configured to determine an identifier associated with a target object;
a second sensor configured to determine a load borne by a machine handling the target object; and
a controller communicatively coupled to the first sensor and the second sensor, the controller configured to determine a load threshold based on the identifier, compare the load with the load threshold to determine whether the load threshold is exceeded, and, on condition that the load threshold is exceeded, selectively restrict movement of the machine.

2. The load verification system of claim 1, wherein the controller is configured to selectively move a handling member towards the target object.

3. The load verification system of claim 1, wherein, while the load threshold is exceeded, the controller restricts movement of a handling member coupled to the target object in one or more directions.

4. The load verification system of claim 1, wherein, upon determining that the load threshold is exceeded, the controller automatically reverses movement of a handling member coupled to the target object.

5. The load verification system of claim 1, further comprising a user interface communicatively coupled to the controller, wherein, upon determining that the load threshold is exceeded, the controller automatically generates an alert for presentation to a user at the user interface.

6. The load verification system of claim 1, further comprising a third sensor configured to detect a presence of the target object, wherein the controller is communicatively coupled to the third sensor, and configured to determine a location of the target object based on the detected presence.

7. The load verification system of claim 6, wherein the third sensor is configured to detect a presence of one or more other objects, and the controller is configured to selectively move a handling member around at least a first object of the one or more other objects.

8. The load verification system of claim 1, wherein the controller is configured to selectively move an extension member between a contracted configuration and an extended configuration for use in selectively positioning a handling member coupled to the target object.

9. The load verification system of claim 1, wherein the controller is configured to selectively move a handling member between an open configuration and a closed configuration for use in selectively handling the target object.

10. A control system for use with an overhead crane, the control system comprising:
a scan unit configured to identify an object associated with the overhead crane;
a load unit configured to determine a load borne by the overhead crane; and
a regulator unit configured to determine a load threshold of the overhead crane based on the identified object, and compare the load with the load threshold to determine an operating mode of the overhead crane.

11. The control system of claim 10, further comprising an actuator unit that selectively moves one or more portions of the overhead crane.

12. The control system of claim 11, wherein the actuator unit restricts movement of a first portion of the one or more portions in one or more directions when the overhead crane is in a loaded operating mode.

13. The control system of claim 11, wherein, upon determining that the overhead crane is in a loaded operating mode, the actuator unit automatically reverses movement of the overhead crane.

14. The control system of claim 10, further comprising an interface unit, wherein, upon determining that the overhead crane is in a loaded operating mode, the interface unit presents an alert to a user.

15. The control system of claim 10, further comprising a vision unit that determines a location of the object relative to the overhead crane.

16. A method for verifying a load for use with an overhead crane, the method comprising:
determining an identifier to identify an object associated with the identifier;
determining a load threshold of the overhead crane based on the identified object;
determining a load borne by the overhead crane when the object is coupled to the overhead crane; and
comparing the load with the load threshold to determine an operating mode of the overhead crane.

17. The method of claim 16, further comprising using the overhead crane to move the object in a first direction, the load determined when the object is in motion.

18. The method of claim 16, further comprising restricting movement of at least a portion of the overhead crane in one or more directions when the overhead crane is in a loaded operating mode.

19. The method of claim 16, further comprising automatically reversing movement of the overhead crane upon determining that the overhead crane is in a loaded operating mode.

20. The method of claim 16, further comprising presenting an alert to a user of the overhead crane.
